(19) United States
(12) Patent Application Publication
(10) Pub. No.: US 2025/0384801 A1
(43) Pub. Date: Dec. 18, 2025

(54) Dynamic Digital Mask for Enhanced Privacy on Electronic Displays through Mimicry of Polarization Effects

(71) Applicants: Elizabeth B. Jacoby, Little Rock, AR (US); Gregory Donald Carson, Rancho Cucamonga, CA (US)

(72) Inventors: Elizabeth B. Jacoby, Little Rock, AR (US); Gregory Donald Carson, Rancho Cucamonga, CA (US)

(21) Appl. No.: 18/950,501

(22) Filed: Nov. 18, 2024

Related U.S. Application Data
(63) Continuation-in-part of application No. 18/746,569, filed on Jun. 18, 2024, now abandoned.

(51) Int. Cl. G09G 3/20; G06T 5/73; G06T 5/90

(52) U.S. Cl. CPC G09G 3/20; G06T 5/73; G06T 5/90; G09G 2320/066; G09G 2320/0666; G09G 2354/00; G09G 2358/00

(57) ABSTRACT

The invention provides a software-based solution for enhancing privacy on digital displays by using a dynamic digital mask that mimics polarization effects. The mask adjusts contrast, reduces reflections, and enhances colors in specific areas of the screen to limit visibility from side angles, ensuring that sensitive content is visible only to the user directly in front of the screen. This system adapts in real-time based on environmental factors like ambient light and user position and allows for extensive customization to meet individual privacy needs. Compatible across various devices, this invention offers a versatile, cost-effective alternative to traditional physical privacy filters and hardware-dependent solutions, significantly improving the user's ability to protect sensitive information on smartphones, tablets, and computers.

### CROSS-REFERENCE TO RELATED APPLICATIONS

This application is a continuation-in-part of U.S. patent application Ser. No. 18/746,569, filed on Jun. 18, 2024, by Elizabeth B. Jacoby, titled “Neck Position Training Method.” This application claims the benefit of priority to the aforementioned application under 35 U.S.C. § 120. The entire contents of the aforementioned application are hereby incorporated by reference as permitted under 37 C.F.R. § 1.57 for all purposes.

### BACKGROUND OF THE INVENTION

### Technical Field

This invention relates generally to a digital privacy enhancement system. This invention relates more particularly to an apparatus/device for applying a digital mask to screen content to mimic polarization effects, thereby enhancing privacy for users on smartphones, tablets, and computers.

This invention relates generally to apparatuses and devices for improving screen privacy by dynamically adjusting visual output based on environmental and user-specific factors. This method also can be used with various digital devices, including laptops, desktops, and smart TVs, to ensure consistent privacy protection across different platforms. This invention relates more particularly to a software-based solution that selectively applies contrast adjustments, reduces reflections, and enhances colors to limit screen visibility from side angles, thereby safeguarding sensitive information from unauthorized viewing.

The invention pertains to the field of digital privacy technology, specifically within the domain of image and video processing systems for enhancing user privacy on electronic display devices. This field involves the development of apparatuses and methods for selectively altering the visual output on screens to prevent unauthorized viewing by adjusting contrast, reducing reflections, and enhancing colors in specific areas of the display. The invention may be classified under U.S. Patent Classification codes related to electronic display technologies, digital image processing, and privacy-enhancing techniques. These classifications encompass innovations designed to improve the security and confidentiality of information displayed on devices such as smartphones, tablets, computers, and other digital screens.

### Background Art

Several current technologies provide similar utility to the claims of the present invention for using a digital mask to mimic polarization effects for private viewing on digital devices. These technologies primarily focus on reducing the visibility of screen content from side angles and enhancing privacy for users of smartphones, tablets, and computers.

Physical Privacy Filters: Description: Privacy filters are physical screens that can be attached to the display of a smartphone, tablet, or computer. These filters narrow the viewing angle, making the screen appear dark or obscured when viewed from the side. Utility: These filters directly address the need for privacy by limiting the viewing angle, ensuring that only the person directly in front of the screen can view the content clearly.

Software-Based Privacy Solutions: Dynamic Blurring: Some applications and operating systems offer software solutions that blur or obscure content when the device detects that it is being viewed from an angle. Utility: These solutions work similarly to the described patent claims by dynamically altering screen content to enhance privacy based on the viewer's position.

Privacy Mode in Displays: This technology is integrated into certain laptops and allows the user to activate a privacy mode that narrows the viewing angle with a single key press. When activated, the screen content becomes difficult to see from the side, mimicking the effect of a privacy filter but without the need for a physical accessory. Utility: This technology achieves the same utility as the patent claims by using built-in hardware and software to limit the visibility of the screen content from side angles.

Customizable Screen Filters: Blue Light Filters with Privacy Settings: Some screen filter apps designed to reduce blue light exposure also include options to dim or obscure parts of the screen, which can be used to enhance privacy. These apps may not provide the same level of privacy as dedicated privacy filters, but they offer a software-based solution that can mimic some of the effects described in the patent claims. Utility: These apps allow users to adjust screen brightness and contrast, potentially reducing visibility from side angles, similar to the effects of the described numerical masks.

Advanced Display Technologies: Micro-LED Displays with Directional Light Control: Emerging display technologies, such as micro-LEDs, have the potential to control light emission directionally, which could be used to create displays that naturally limit viewing angles without the need for additional filters or software. Utility: While still in development, these displays could inherently limit side-angle visibility, offering a hardware-based solution that aligns with the goals of the patent claims.

Current technologies that provide similar utility to the described patent claims include physical privacy filters, software-based privacy solutions like dynamic blurring, integrated privacy modes in displays, and emerging display technologies with directional light control. These technologies collectively address the need for enhanced privacy on digital devices by limiting the viewing angle, reducing reflections, and adjusting screen content to obscure it from unauthorized viewers.

The patent claims of the present invention for a digital mask to mimic the visual effects of polarization for enhancing privacy on smartphones, tablets, and computer screens offer several advantages over existing prior art:

Dynamic and Context-Aware Adjustments: Advantage: The claims describe a system that dynamically adjusts the contrast, reduces reflections, and enhances colors based on real-time factors such as the viewer's position, ambient light conditions, and specific content displayed on the screen. This adaptability provides a more refined and user-specific privacy experience compared to static physical privacy filters or pre-set software options. Existing Art: Physical privacy filters are static and cannot adjust based on changing environmental conditions or user behavior. Software-based solutions are effective but typically offer less granularity in real-time adjustment compared to what is described in the claims.

Selective Application of Effects: Advantage: The claims allow for the selective application of the privacy mask to specific regions of the screen, such as areas displaying sensitive information, while leaving other areas unaffected. This level of control can maintain usability and visual quality where privacy is not a concern while securing critical information. Existing Art: Current technologies, such as full-screen privacy filters or blurring apps, typically apply a uniform effect across the entire screen. This can lead to a less optimal user experience, as non-sensitive content is also obscured, reducing overall visibility and usability.

Integration with Existing Hardware: Advantage: The described method can be implemented through software without the need for additional hardware. This makes it more accessible and cost-effective for users, as it can be integrated into existing devices through software updates or applications. Existing Art: Physical privacy filters require purchasing and installing additional hardware, which can be cumbersome and may not be suitable for all devices. Moreover, integrated solutions like HP Sure View are hardware-dependent, limiting their availability to specific models.

Enhanced Privacy in High Ambient Light Conditions: Advantage: The claims specify techniques for optimizing privacy in environments with high ambient light, such as outdoors. By dynamically adjusting the screen's contrast and reflection reduction based on the lighting conditions, the system ensures privacy even when physical filters or standard software might struggle. Existing Art: Physical privacy filters and current software solutions may not perform well in bright environments where reflections and glare can reduce their effectiveness.

User Customization and Control: Advantage: The claims allow for user customization of the privacy effects, enabling users to tailor the level of contrast adjustment, reflection suppression, and color enhancement according to their specific needs and preferences. This flexibility offers a more personalized and effective privacy solution. Existing Art: Many existing privacy solutions offer limited or no customization. Users often have to choose between a fully activated privacy mode or none at all, without the ability to fine-tune the effects.

Hybrid Approach with Physical Filters: Advantage: The claims include the option to combine the digital mask with physical privacy filters, further enhancing privacy by leveraging the strengths of both methods. This hybrid approach can maximize effectiveness, particularly in environments where either solution alone might not suffice. Existing Art: Most current technologies do not offer a seamless integration between physical and digital privacy solutions, potentially limiting their overall effectiveness.

The described patent claims of the present invention offer significant improvements over existing prior art by providing a more dynamic, customizable, and integrated approach to screen privacy. These enhancements address the limitations of current technologies, offering users a flexible and effective means of protecting their screen content from unauthorized viewing under various conditions.

In light of the foregoing prior art, there is a need for a more adaptive and flexible privacy solution to better protect sensitive information displayed on digital devices while maintaining usability and visual clarity. Existing technologies, such as static physical privacy filters and hardware-dependent integrated displays, often lack the adaptability required to address varying environmental conditions, such as changes in ambient light or viewing angles. Furthermore, these solutions typically do not offer the user the ability to selectively apply privacy effects to specific regions of the screen, which can result in either over-protection or under-protection of screen content. The proposed invention addresses these shortcomings by providing a dynamic, software-based privacy solution that can be customized and optimized in real-time, ensuring that the privacy protection is both effective and user-friendly.

### BRIEF SUMMARY OF THE INVENTION

The invention relates to a digital mask technology designed to mimic the visual effects of polarization for enhancing privacy on digital devices such as smartphones, tablets, and computers. The inventive concept revolves around the use of a numerical array, or digital mask, that dynamically adjusts contrast, reduces reflections, and enhances colors in specific areas of an image or video. This process is aimed at limiting the visibility of sensitive content to unauthorized viewers, particularly when the device is viewed from side angles.

Unlike traditional privacy solutions, which often rely on static physical filters or hardware-dependent integrated displays, this invention offers a software-based, device-independent approach. The digital mask can be applied selectively, allowing users to target specific regions of the screen for privacy protection while maintaining the visibility and usability of other areas. This adaptability is achieved through real-time adjustments based on environmental factors such as ambient light and the user's viewing angle, ensuring that the privacy protection remains effective under varying conditions.

The key objects of the invention are to provide a more flexible and customizable privacy solution that can be easily integrated into existing digital devices without the need for additional hardware, offering enhanced privacy while preserving user experience and device performance.

The digital mask represents a significant advancement over prior art by addressing the limitations of current privacy technologies and offering a more sophisticated and user-friendly solution for protecting sensitive screen content.

### Related Art and Problems in the Prior Art

Physical Privacy Filters: Description: Physical privacy filters are attachments that can be placed over screens to limit the viewing angle, ensuring that screen content is visible only to the person directly in front of the device. These filters are typically made of materials that polarize light or block light from certain angles.

Problems: Lack of Adaptability: Physical privacy filters are static and do not adjust to changing conditions, such as variations in ambient light or user position. This can result in suboptimal performance in different environments. Inconvenience: Users must purchase and attach these filters separately, which can be cumbersome. They also make the screen darker for the user, affecting usability in some cases. Compatibility Issues: Physical filters need to be matched to the exact screen size and type, making them less versatile and more difficult to use across different devices.

Software-Based Privacy Solutions: Dynamic Blurring and Shading: Some software applications, such as screen dimming apps or privacy modes in operating systems, offer limited privacy features by blurring or shading parts of the screen when sensitive content is detected or when the user is not directly viewing the screen.

Problems: Limited Customization: Most software solutions provide only basic, broad-stroke adjustments like screen dimming or full-screen blurring, without the ability to selectively target specific areas of the screen or adjust the intensity of the effect based on context.

Performance Impact: Real-time processing of dynamic blurring or shading can be resource-intensive, potentially leading to reduced device performance, especially on older or less powerful hardware. Inconsistent Effectiveness: These solutions often struggle in brightly lit environments or when dealing with content that has high contrast, making them less effective at protecting privacy in all scenarios.

Integrated Privacy Displays: Description: These technologies integrate privacy filters directly into the display hardware, allowing users to toggle privacy modes that narrow the viewing angle and obscure the screen from side viewers.

Problems: Hardware Dependency: These solutions are tied to specific devices and cannot be easily transferred to other screens or devices. Users must purchase devices with this feature pre-installed, limiting their options. Fixed Intensity: The level of privacy protection is typically fixed, with limited or no options for user customization or adjustment. This can result in either too much or too little privacy protection depending on the user's environment and needs.

Problems Solved by the Invention: The digital mask technology described in the patent claims overcomes many of the limitations found in existing privacy solutions by offering a more flexible, dynamic, and user-customizable approach:

Dynamic and Context-Aware Adjustments: Unlike static physical filters or fixed-intensity privacy screens, the digital mask can adjust in real time based on environmental conditions (e.g., ambient light) and user behavior (e.g., viewing angle). This ensures that the privacy protection is always optimal, regardless of changing conditions.

Selective Application of Effects: The invention allows for privacy effects to be selectively applied to specific areas of the screen, preserving usability and visibility where privacy is not needed while protecting sensitive information. This level of control is not available in most existing privacy solutions.

User Customization: Users can manually adjust the level of privacy protection, tailoring the system to their specific needs and preferences. This is a significant improvement over prior art, which often provides limited or no customization options.

Software-Based, Device-Independent Solution: The digital mask can be implemented on a wide range of devices without the need for specialized hardware, making it more accessible and cost-effective compared to hardware-dependent solutions like HP Sure View.

Enhanced Privacy in High Ambient Light Conditions: By dynamically reducing reflections and adjusting contrast in real time, the digital mask provides effective privacy even in bright environments, where traditional privacy solutions often fail.

In summary, the invention described in the patent claims offers a more versatile, adaptable, and user-friendly approach to screen privacy than the existing prior art, addressing key limitations related to flexibility, customization, and effectiveness across different environments.

The invention offers several key advantages over existing privacy technologies:

Dynamic and Context-Aware Protection: The digital mask adjusts in real-time based on environmental factors, ensuring consistent privacy protection across varying conditions, unlike static solutions.

Selective Application: It allows privacy effects to be selectively applied to specific screen areas, maintaining usability by protecting only sensitive content.

User Customization: Users can tailor privacy settings to their preferences, providing a more personalized and effective privacy experience.

Device Independence and Cost-Effectiveness: As a software-based solution, the digital mask is widely accessible and can be implemented on various devices without needing specialized hardware, reducing costs.

Enhanced Performance in Bright Environments: The invention is optimized for high ambient light conditions, maintaining effective privacy where traditional filters often fail.

According to one aspect of the invention there is a Dynamic Digital Mask for Enhanced Privacy on Electronic Displays through Mimicry of Polarization Effects comprising all features of claim 1: (A) Receiving a digital image or a video data intended for display on a screen; (B) Applying a numerical mask to said digital image or said video data, wherein said numerical mask is configured to: (i) Adjust a contrast in specific regions to mimic an enhanced contrast of polarized light or reduce visibility from side viewing angles; (ii) Reduce an intensity of reflections in identified reflective areas to minimize glare or enhance private viewing; (iii) Enhance a color saturation in predetermined areas to simulate polarized light effects or improve private viewing by enhancing colors for a viewer positioned directly in front of said screen; and (C) Outputting a processed image or video on said digital display with said enhanced visual effects or privacy adjustments applied. Further features of the invention are disclosed in dependent claims.

According to one aspect of the invention there is a Dynamic Digital Mask for Enhanced Privacy on Electronic Displays through Mimicry of Polarization Effects comprising all features of claim 2: (A) A processor configured to execute instructions; (B) A memory for storing said instructions; (C) A display device for presenting an image or a video; (D) Said instructions, when executed by said processor, cause said system to: (i) Apply a numerical mask to adjust contrast, reduce reflections, and enhance colors in specific areas to mimic a polarization or limit a visibility to viewers directly in front of said screen; and (ii) Render a processed image or a processed video on said digital display with polarization-mimicking effects or privacy-enhancing effects; (E) An input device that allows a viewer to manually adjust an intensity of said polarization or a privacy effect. Further features of the invention are disclosed in dependent claims.

These advantages collectively represent a significant improvement in screen privacy technology, offering greater flexibility, usability, and effectiveness.

The invention is more than mere software because it integrates and interacts with various hardware components of digital devices to create a comprehensive privacy solution that is dynamic and context-aware. While the core of the invention is software-driven, its functionality is deeply intertwined with the physical attributes and capabilities of the device, such as sensors, display technology, and user interfaces.

Integration with Hardware Sensors: The invention leverages environmental sensors like ambient light sensors, proximity sensors, and gyroscopes to gather real-time data about the device's surroundings and the user's position. This data is critical for the software to adjust the digital mask effectively. For example, if the ambient light sensor detects bright sunlight, the software increases the contrast and reduces reflections on the display to enhance privacy. This interaction between software and hardware ensures that the privacy protection is responsive and adaptive to changing conditions.

Real-Time Processing and Display Management: The software not only processes the digital mask but also manages how it is applied to the display in real-time, interacting directly with the device's graphics processing unit (GPU) and display controller. This involves optimizing the display output based on the user's interactions and the environment, making the invention highly dependent on the hardware's processing power and display capabilities. The software dynamically adjusts pixel brightness, contrast, and color saturation, which requires precise control over the display hardware to ensure smooth and seamless operation.

User Interface and Physical Controls: The invention includes a user interface that allows for manual adjustments and customization of privacy settings. This interface could be integrated with physical buttons or touchscreen controls, providing a tactile aspect to the invention. Additionally, the software may interact with physical components like a power button or a dedicated privacy mode switch, further demonstrating that the invention is not just software but a holistic solution that encompasses both software and hardware elements.

Hybrid Approach with Physical Filters: The invention can be used in conjunction with physical privacy filters, enhancing their effectiveness by dynamically adjusting the digital mask in response to user actions and environmental changes. This hybrid approach combines the best of both software and hardware solutions, creating a more robust and versatile privacy system.

Cross-Platform and Device-Independent Implementation: While the software aspect of the invention is crucial, its ability to be implemented across various devices with different hardware configurations highlights its adaptability and integration with physical components. The invention's utility is not confined to a specific software environment but is designed to interact with and enhance the hardware features of a wide range of digital devices.

The invention transcends mere software by integrating with and leveraging the device's hardware to create a dynamic, context-aware privacy solution. Its functionality depends on real-time interaction with sensors, display technology, and user interfaces, making it a comprehensive system that goes beyond traditional software applications.

The invention will now be described, by way of example only, with reference to the accompanying drawings in which:

### BRIEF DESCRIPTION OF THE SEVERAL VIEWS OF THE DRAWINGS

FIG. 1 is a flowchart of the dynamic digital mask for enhanced privacy on electronic displays through mimicry of polarization effects according to the invention; and

FIG. 2 is a side view of a user or viewer viewing a display device using the dynamic digital mask for enhanced privacy on electronic displays through mimicry of polarization effects according to the invention.

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “comprise,” or variations thereof such as “comprises” or “comprising,” will be understood to imply the inclusion of a stated element, integer or step, or group of elements integers or steps, but not the exclusion of any other element, integer or step, or group of elements, integers or steps.

Index of Labelled Features in Figures. Features are listed in numeric order.

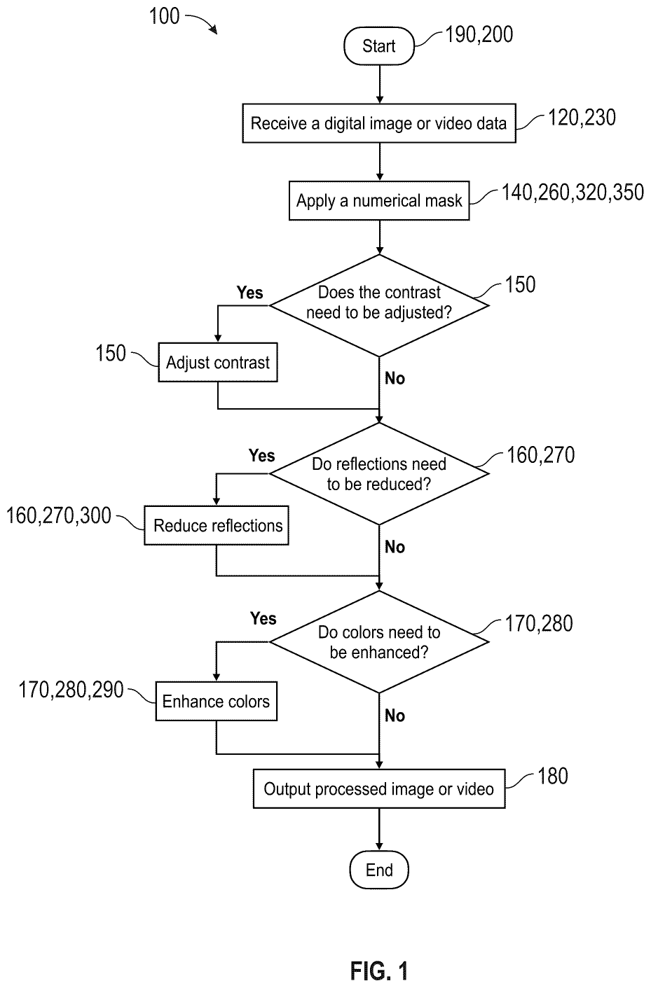

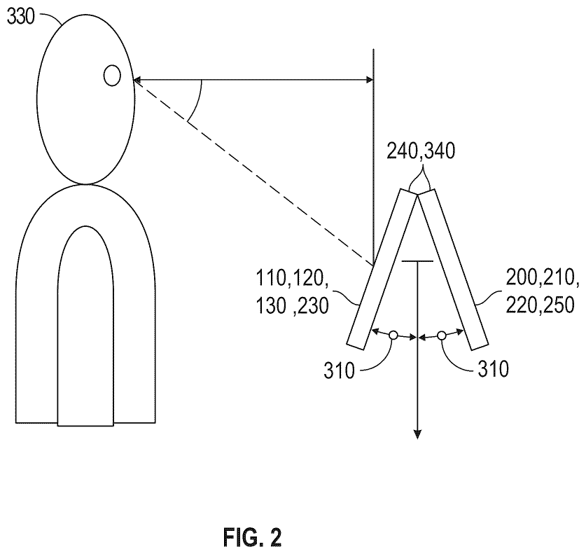

Referring to the Figures, there is shown in FIGS. 1 and 2 the following features:

Element 100 which is a method for enhancing visual effects or privacy on a digital display.

Element 110 which is a digital display.

Element 120 which is a digital image or a video data.

Element 130 which is a screen.

Element 140 which is a numerical mask.

Element 150 which is a contrast in specific regions to mimic an enhanced contrast of polarized light or reduce visibility from side viewing angles.

Element 160 which is an intensity of reflections in identified reflective areas to minimize glare or enhance private viewing.

Element 170 which is a color saturation in predetermined areas to simulate polarized light effects or improve private viewing by enhancing colors for a viewer positioned directly in front of the screen.

Element 180 which is a processed image or video.

Element 190 which is a system for providing enhanced visual effects or privacy on a digital display.

Element 200 which is a processor configured to execute instructions.

Element 210 which is an instruction.

Element 220 which is a memory for storing the instructions.

Element 230 which is an image or a video.

Element 240 which is an input device.

Element 250 which is a non-transitory computer-readable storage medium.

Element 260 which is a gradient.

Element 270 which is a blur reduction filter or an intensity reduction filter.

Element 280 which is a plurality of colors, including a blue of a sky or a green of a foliage.

Element 290 which is a color enhancement.

Element 300 which is a reduction of the intensity of reflections.

Element 310 which is a viewing angle.

Element 320 which is a content of said digital image or said video data such that contrast adjustments, reflection reduction, and color enhancement are optimized in real time.

Element 330 which is a user or viewer.

Element 340 which is a user interface.

Element 350 which is a level of contrast reduction, reflection suppression, and color enhancement to tailor said privacy effect to specific needs of said viewer.

The invention is significantly more than an abstract idea because it involves the practical application of both hardware and software to solve real-world privacy issues on digital displays. Here's how it goes beyond the realm of abstract ideas:

Interaction with Physical Hardware: Practical Implementation: The invention involves the practical use of environmental sensors, such as ambient light sensors and gyroscopes, to gather real-time data. This data is then used to dynamically adjust the privacy settings of the digital display. This physical interaction with hardware components makes the invention a concrete application, not just a theoretical concept. Real-Time Adjustments: The digital mask dynamically alters the display output in response to changing environmental conditions, such as lighting or the user's position. This requires real-time processing and precise control over the device's hardware, including the display and GPU, which are tangible components.

Technical Solution to a Technical Problem: Addressing Screen Privacy: The invention tackles the specific, technical problem of unauthorized viewing of screen content by those not directly in front of the display. By applying a digital mask that adjusts contrast, reduces reflections, and enhances colors, the invention provides a technical solution that improves the privacy of digital displays in various environments. Real-World Impact: The system's ability to adapt to different lighting conditions and viewing angles has immediate practical benefits, making screen content more secure and less prone to unauthorized viewing. This is a direct application of technology to enhance user privacy, far beyond an abstract idea.

Integration with User Behavior: User-Centric Design: The invention takes into account the behavior of the user, allowing for real-time customization of privacy settings based on individual preferences and environmental changes. This interaction between the user and the device through the invention's interface and controls represents a concrete, actionable system, rather than a theoretical concept. Customization and Control: Users can actively engage with the system by adjusting privacy settings, which affects how the digital mask interacts with the hardware. This level of user control and feedback is a tangible aspect that distinguishes the invention from an abstract idea.

Cross-Platform and Multi-Device Functionality: Broad Applicability: The invention is designed to work across multiple devices, including smartphones, tablets, and computers. It leverages the specific hardware capabilities of each device, such as different types of displays and sensors, to implement the privacy-enhancing features. This adaptability to various physical devices further demonstrates that the invention is a practical solution and not merely an abstract idea.

Hybrid Implementation with Physical Components: Combination with Physical Filters: The invention can also be used in conjunction with physical privacy filters, enhancing the effectiveness of these filters through digital adjustments. This hybrid approach, combining software and physical elements, underscores the invention's practical application in the real world.

Legal Perspective: Beyond Abstract Ideas: In patent law, an abstract idea might involve a general principle or concept without a specific application. However, this invention applies a specific technological process to solve a particular problem-unauthorized viewing of digital content-which courts have generally recognized as patent-eligible subject matter when it involves a specific application of technology.

The invention is more than an abstract idea because it integrates with physical hardware, solves a specific technical problem, and provides a practical, user-driven solution that operates across multiple devices. Its ability to dynamically interact with and control physical components to enhance privacy on digital displays clearly grounds it in the realm of tangible, real-world applications.

The linear light mask is implemented as a digital image mask or matrix array that is passed over any image displayed under it as an electronic operation to transform the display. The mask changes the pixel brightness, hue, and saturation to brightest at a center line directly perpendicular to the front of the screen that it is displayed upon. This mask is comprised of a representation of zeros and ones in memory that is used to transform the data that is passed to the mask. Alternatively, the data that the mask is passed over acts as a filter. The impact of the mask is to cause the brightness of the light to only be visual directly in front of the screen (and/or perpendicular to the screen) it is displayed upon. In other words, the light from the screen is not visually available from an angle or side view other the directly in front of the screen and/or perpendicular to the screen.

There is a version of the present invention wherein the blackout rectangle is created with a linear light mask configured to narrow a side viewing angle to less than thirty degrees from vertical. There is a version of the present invention wherein the blackout rectangle comprises a linear light mask configured to narrow a side viewing angle to less than fifteen degrees from vertical.

Creating a digital mask for linearizing light displayed involves designing a computational filter or mask that adjusts the intensity and distribution of light in a way that makes the output appear more linear. This process is often used in display technologies to improve the accuracy and consistency of light output, particularly in applications requiring precise color and brightness control.

Here is a step-by-step guide to creating such a digital mask:

### Step 1: Understand the Display Characteristics

Measure Display Response: Start by measuring the light output of the display at different input levels. Use a photometer or spectroradiometer to capture the display's response curve.

Generate Gamma Curve: Determine the gamma curve of the display, which describes how the input signal relates to the light output.

### Step 2: Develop a Linearization Algorithm

Inverse Gamma Correction: Calculate the inverse gamma function that will linearize the display's response. This involves creating a function that maps the desired linear light output to the corresponding non-linear input signal.

Create LUT (Look-Up Table): Use the inverse gamma function to generate a LUT that maps linear light values to the corresponding input values for the display.

### Step 3: Implement the Digital Mask

Software Implementation: Develop software that applies the LUT to the input signal before it is sent to the display. This can be done using shaders in graphics programming or image processing software.

Hardware Implementation: For real-time applications, consider implementing the LUT in hardware, such as within a display controller or FPGA (Field Programmable Gate Array).

### Step 4: Calibration and Adjustment

Calibration: Regularly calibrate the display to ensure that the linearization remains accurate over time. This may involve re-measuring the display response and updating the LUT.

Adjustment: Allow for adjustments based on specific viewing conditions or content requirements, as different applications may need slightly different linearization characteristics.

### Step 5: Testing and Validation

Test with Standard Patterns: Use standard test patterns and images to verify that the linearization mask is working correctly. Check for uniformity and consistency in brightness and color.

User Feedback: Gather feedback from end-users to ensure that the perceived image quality meets expectations and make any necessary adjustments.

### Tools and Techniques

Photometric Equipment: Use high-precision photometers or spectroradiometers to measure the light output accurately.

Image Processing Software: Utilize software like Adobe Photoshop, MATLAB, or custom scripts to develop and apply the LUT.

Programming Languages: Implement the algorithm using programming languages such as Python, C++, or shader languages like GLSL.

In a preferred embodiment of the invention, there is a screen display lighting method comprising: creating a (digital) blackout rectangle configured to be applied to said screen display; configuring said blackout rectangle to be displayed visually in front of an application that presents an image or a video on said screen display window; and configuring said blackout rectangle to be displayed visually only from a position perpendicular to said screen display, and optionally further comprising configuring said blackout rectangle to visually display only within up to plus or minus thirty degrees and/or fifteen degrees of said position perpendicular to said screen display.

### How to Make the Invention

### Software Development:

Designing the Numerical Mask Algorithm: Begin by crafting an algorithm that generates a digital mask, which dynamically manipulates the visual characteristics of a display. This mask should adjust contrast, suppress reflections, and enhance colors in specific regions of an image or video displayed on a screen. The mask is represented as a numerical array, where each element corresponds to a pixel or group of pixels, controlling their visual properties.

Adaptive Design: Incorporate machine learning techniques to allow the algorithm to learn from user behavior and environmental conditions. For instance, it could learn to recognize commonly viewed sensitive areas (like email fields or payment forms) and apply stronger privacy settings to these areas.

Integrating Environmental Sensors: Utilize the device's built-in sensors, such as ambient light sensors, proximity sensors, and gyroscopes, to gather real-time data on environmental conditions and user orientation. This data informs the algorithm's adjustments to ensure the privacy mask responds appropriately to changes in lighting, the user's movement, or the angle at which the device is being viewed.

Advanced Sensor Fusion: Implement sensor fusion techniques to combine data from multiple sensors for more accurate detection of the user's environment and posture. For example, combining data from the ambient light sensor and the accelerometer could allow the software to detect when a user is on public transport and automatically tighten privacy settings.

Developing a User-Friendly Interface: Create an intuitive interface that allows users to easily customize privacy settings. This interface could include sliders for adjusting the intensity of contrast, reflection suppression, and color enhancement, as well as preset modes for common scenarios like “Work,” “Public,” or “Outdoor.”

Interactive Tutorials: Include interactive tutorials within the interface to guide users through setting up and optimizing their privacy preferences. These tutorials could demonstrate how different settings impact privacy and usability, helping users make informed choices.

Implementing Real-Time Processing: Optimize the algorithm to function in real-time, processing each frame of a video or each image as it is displayed without noticeable latency. This involves leveraging GPU acceleration or other parallel processing techniques to ensure that privacy enhancements are applied seamlessly.

Performance Optimization: Implement adaptive processing techniques where the algorithm prioritizes privacy enhancement for areas of the screen displaying sensitive content, reducing the load on the device's hardware by not applying intensive processing to non-critical areas.

Ensuring Compatibility Across Devices: Develop the software to be platform-independent, enabling it to run on various operating systems and device types (smartphones, tablets, laptops). This requires using cross-platform development frameworks and ensuring that the software integrates smoothly with different display management systems.

Cloud Integration: Consider integrating cloud-based processing for devices with limited processing power. The cloud service could handle more intensive aspects of the privacy enhancement, sending back optimized display instructions to the user's device.

### Testing and Optimization:

Prototype Development and Testing: Develop multiple prototypes of the software and test them under diverse conditions, including various lighting environments, viewing angles, and types of displayed content (e.g., text-heavy documents, multimedia, high-contrast images). Testing should also include different device types and screen sizes to ensure broad applicability.

User Feedback Integration: Establish a beta testing program where users can provide feedback on the software's performance and usability. Use this feedback to refine the algorithm, particularly focusing on enhancing user experience and minimizing any disruptions to normal device use.

Performance Optimization: Focus on optimizing the software for minimal impact on device performance, ensuring that the privacy enhancements do not significantly affect battery life, processing power, or overall device speed. This might involve implementing power-saving modes or reducing the frequency of adjustments in less critical scenarios.

Algorithm Refinement: Continuously refine the algorithm to balance the trade-off between privacy protection and device performance. Implementing adaptive algorithms that scale their operations based on the device's current load could be beneficial.

Final Testing and Quality Assurance: Conduct extensive testing across a wide range of devices and use cases to ensure robustness and reliability. This phase should include stress testing in extreme conditions, such as direct sunlight or low battery scenarios, to confirm that the privacy features remain effective.

Security Testing: Ensure that the software itself is secure and does not introduce vulnerabilities, particularly since it deals with sensitive user information. Implement encryption and secure data handling practices to protect user settings and data.

### How to Use the Invention

### Installation and Setup

Installing the Software: Users can download and install the software from an app store or a secure website. During installation, the software will guide the user through initial setup, which includes granting necessary permissions for accessing the device's sensors and display settings.

Permissions Management: The software will request access to various sensors (e.g., light sensor, gyroscope) during installation, explaining why each permission is necessary for the software to function correctly. It will also provide a privacy policy to reassure users about how their data will be handled.

Initial Configuration: Upon first use, the software guides the user through a setup process to calibrate the screen based on their environment and preferences. This may include setting default privacy levels for different situations (e.g., indoor, outdoor) and adjusting the sensitivity of the mask to ambient light and viewing angles.

Personalization Options: During setup, users can select from pre-configured profiles or create custom profiles that best suit their daily routines. The software could suggest optimal settings based on the user's initial inputs and device usage patterns.

### Customization and Everyday Use

Customizing Privacy Settings: Users can access the software's settings at any time to customize their privacy preferences. They can adjust sliders for contrast reduction, reflection suppression, and color enhancement, and can save different profiles for specific environments like “Office,” “Public Transport,” or “Home.”

Automated Adjustments: The software can be set to automatically switch between profiles based on detected environmental changes, such as moving from a dimly lit room to a bright outdoor setting. Users can override these automatic adjustments if desired.

Activating Privacy Mode: The privacy features can be manually activated when the user anticipates needing enhanced privacy, such as during a meeting or while working in a public space. Alternatively, the software can be set to activate privacy mode automatically under certain conditions, like when the device detects it is in a public location.

Quick Access: Users can activate privacy mode quickly via a shortcut or widget on their device's home screen, enabling or disabling the feature with a single tap.

Using the Device Normally: While active, the software runs in the background, unobtrusively applying the digital mask to protect sensitive content. Whether the user is browsing the internet, viewing documents, or watching videos, the software ensures that content is visible only to them.

Seamless Integration: The software is designed to integrate seamlessly with the device's existing user interface, ensuring that privacy enhancements do not interfere with the user's normal interactions or degrade the quality of the display.

### Adaptive Adjustments:

Real-Time Privacy Adaptation: The software continuously monitors environmental conditions and user behavior, adjusting the privacy mask in real-time to maintain optimal privacy protection. For instance, in bright sunlight, the software might increase the strength of contrast adjustments to counteract glare.

User Feedback Loop: The software can include a feedback loop where users can provide real-time input on the effectiveness of the privacy settings. The software could then learn from this feedback, improving its automatic adjustments over time.

Manual Overrides: If the user needs to change the privacy settings quickly, they can do so through the software's interface, overriding the automatic adjustments. This feature ensures that the user maintains full control over their privacy settings at all times.

Emergency Privacy Toggle: An emergency toggle feature could instantly activate the strongest privacy settings, obscuring all screen content from side angles. This could be particularly useful in situations where the user needs immediate, enhanced privacy.

The invention provides a sophisticated and user-friendly solution for enhancing privacy on digital screens through the use of a digital mask that mimics polarization effects. Users can install the software on their devices, customize settings to suit their needs, and benefit from real-time adaptive privacy protection. The software is designed to be efficient, effective, and easy to use, offering a significant improvement over existing privacy technologies by providing dynamic, context-aware adjustments and extensive user customization options. This ensures that sensitive information displayed on screens remains secure from unauthorized viewing under a wide range of conditions.

There can be potential speed issues when using a linear mask to alter the presentation of video or photos on a screen. These issues arise from the computational load associated with applying the mask in real-time, especially if high-resolution images or videos are involved. Here are the key factors that influence performance:

Real-Time Processing Overhead: Video Frame Rate: Videos typically run at 30 to 60 frames per second (fps), and applying a linear mask to each frame in real-time requires significant processing power. For high-resolution videos, this becomes computationally intensive, potentially causing frame drops, delays, or stuttering in playback. High-Resolution Images: If dealing with high-resolution images or videos (e.g., 4K or higher), the number of pixels that need to be processed increases exponentially. This can slow down the mask's application, especially on devices with limited GPU or CPU (central processing unit) power.

GPU vs. CPU Processing: GPU Acceleration: Applying a linear mask can benefit from GPU acceleration, which is optimized for parallel processing and handling large numbers of pixels simultaneously. On devices with powerful GPUs, such as modern smartphones and computers, the speed issue can be mitigated, but older or less powerful devices may struggle. CPU Bottleneck: If the processing is handled by the CPU rather than the GPU, it can become a bottleneck. CPUs are generally not optimized for high-speed, pixel-by-pixel image manipulation, and this can slow down the application of the mask, especially if multiple effects like contrast adjustment, reflection reduction, and color enhancement are being applied simultaneously.

Software Optimization: Efficiency of the Algorithm: The efficiency of the software algorithm used to apply the linear mask plays a major role. An optimized algorithm with efficient data handling and parallel processing can reduce the impact on performance. Poorly optimized algorithms can cause significant slowdowns, particularly in resource-constrained environments. Real-Time Adjustments: If the mask is dynamically adjusting based on real-time conditions, such as user movement or changing ambient light, additional processing is needed to continuously update the mask. This increases the computational demand and can affect the overall speed and smoothness of the experience.

Device-Specific Considerations: Mobile Devices vs. Desktops: While desktops and high-end laptops generally have more powerful GPUs and CPUs capable of handling real-time processing of linear masks, mobile devices may struggle more due to their lower processing power. On smartphones or tablets, energy consumption and thermal throttling may also play a role, reducing the effective processing speed as the device tries to manage heat and battery life.

Energy Efficiency Concerns: Power Consumption: Applying a linear mask continuously in real-time, especially for video content, can draw significant power from mobile devices, leading to faster battery drain. This is particularly relevant for devices that rely on real-time sensor inputs (like ambient light or motion detection) to adjust the mask dynamically.

### Mitigating Speed Issues

Using Efficient Libraries: Leveraging efficient video and image processing libraries such as OpenCV or GPU-accelerated frameworks like Vulkan or Metal can significantly reduce the processing overhead.

Adaptive Processing: Applying the mask only to regions of interest (such as the center of the screen or sensitive areas) rather than the entire image or video can reduce the computational load and improve speed.

Preprocessing: Preprocessing static content (like photos) can mitigate speed issues since the linear mask can be applied once rather than continuously. For video, buffering frames and applying the mask ahead of real-time can also help.

Speed issues when using a linear mask to alter the presentation of video or photos depend largely on the device's processing power, the optimization of the software, and whether real-time adjustments are necessary. On high-end devices with optimized algorithms and GPU support, the speed issues can be minimized. However, for lower-end devices or unoptimized implementations, performance may suffer, leading to slower frame rates or reduced image quality.

the invention could potentially be adapted to show two different images to two different people viewing the same screen from different angles, by leveraging the concept of directional light control in combination with the digital mask technology. Here's how this can be achieved:

Directional Light Control: Concept: Modern display technologies such as parallax barriers and lenticular displays already allow different content to be shown to viewers at different angles. These technologies work by directing light in different directions so that each eye (or viewer) sees a different image. For example, in glasses-free 3D displays, different images are sent to each eye, creating a stereoscopic effect. Adaptation: The invention's digital mask could be used in combination with directional light control technology to manage which content is shown at different angles. By applying masks selectively, the screen could display one image at one angle and another at a different angle.

Applying Different Masks for Different Angles: Mask Customization: The digital mask technology described in the invention can be enhanced to apply different masks depending on the viewer's angle. Each mask could selectively control the contrast, reflection, and brightness to show completely different images based on the direction from which the screen is being viewed. Real-Time Adjustment: Using sensors like gyroscopes and cameras to detect the position and angle of the viewers, the invention can apply different masks to different sections of the screen, ensuring that different images are shown depending on where a viewer is standing or sitting.

Use of Multi-View Display Technology: Lenticular and Parallax Barrier Displays: These are display types that use physical light filters or lenses to direct light in specific directions. Combining these technologies with the digital mask could allow for even more precise control, letting each viewer see entirely different content based on their viewing position. This is similar to what is used in glasses-free 3D displays, but instead of showing slightly different images to create depth, the invention could be adapted to show entirely different images. Example Use Case: In a retail environment, one person could see a promotional video for a product while another person, standing at a different angle, could see a pricing or informational display, all on the same screen.

Software and Hardware Integration: Software Coordination: The digital mask would need to work in conjunction with the hardware (like a multi-view display) to ensure that each viewer sees the correct content. The mask would be responsible for applying visual effects and controlling the image seen by each viewer, while the hardware would direct the light accordingly. Advanced Implementation: By dividing the screen into segments and controlling which pixels are visible at different angles, the invention could ensure that each viewer sees distinct content. For example, a family could watch two different TV shows on the same screen depending on where they are sitting.

Challenges: Resolution Reduction: One drawback is that multi-view systems sometimes reduce the effective resolution for each viewer, as the screen's pixel output is divided between different viewing angles. Viewing Angles: This method works best when the number of different viewing angles is limited and clearly defined. Managing more than two different perspectives could become complex and might reduce the image quality for each viewer.

While the current focus of the invention is on improving privacy by dynamically adjusting the display, the technology could be adapted for multi-viewing purposes. By combining digital masks with directional light control techniques, the invention could enable two people to see different images when viewing the screen from different directions. This would require integrating the invention with hardware like lenticular or parallax displays, but the concept is technologically feasible.

In a preferred embodiment of the present invention, there is a method for enhancing visual effects or privacy on a digital display. This method involves receiving digital image or video data intended for display on a screen. A numerical mask is applied to this data, adjusting contrast in specific regions to either mimic the enhanced contrast of polarized light or reduce visibility from side viewing angles. Additionally, the method includes reducing the intensity of reflections in identified reflective areas, minimizing glare, and enhancing color saturation in predetermined areas to simulate polarized light effects or improve private viewing for the user positioned directly in front of the screen. Finally, the processed image or video is outputted on the display with these enhanced visual effects or privacy adjustments applied.

In an alternate embodiment of the present invention, there is a method where the numerical mask applies a gradient of contrast adjustments across the digital image or video data to simulate a natural polarization gradient typically seen in outdoor scenes. This feature adjusts the contrast dynamically to achieve a visual effect similar to what is observed when polarized light interacts with different surfaces outdoors.

In an alternate embodiment of the present invention, there is a method where the reduction in the intensity of reflections is achieved by identifying reflective areas in the image or video based on pixel brightness and uniformity. A blur reduction filter or an intensity reduction filter is applied to these identified areas, effectively minimizing glare and improving the clarity of the image for the viewer.

In an alternate embodiment of the present invention, there is a method where color enhancement is selectively applied to areas containing a plurality of specific colors, such as the blue of a sky or the green of foliage. This enhancement replicates the effect of polarized light on these colors, making the scene appear more vibrant and visually pleasing to the user.

In an alternate embodiment of the present invention, there is a method where the numerical mask is applied selectively to different frames of a video based on motion detection. This ensures that the polarization-mimicking effects are consistent and visually coherent throughout the video playback, providing a smooth viewing experience without disruptive changes in visual quality.

In an alternate embodiment of the present invention, there is a method where the numerical mask applies a gradient that progressively reduces contrast and brightness toward the edges of the screen, making the content difficult to discern from wider viewing angles. This feature enhances privacy by obscuring the content from viewers who are not directly in front of the screen.

In an alternate embodiment of the present invention, there is a method where the reduction of reflection intensity is optimized for environments with high ambient light, such as outdoor settings. This adjustment helps maintain effective private viewing in bright conditions where traditional privacy screens or filters may struggle to block glare.

In an alternate embodiment of the present invention, there is a method where color enhancement is selectively applied based on the viewing angle. Colors are enhanced in areas directly aligned with the viewer's line of sight while being subdued at wider angles, further obscuring the content from side viewers.

In a preferred embodiment of the present invention, there is a system for providing enhanced visual effects or privacy on a digital display. This system comprises a processor configured to execute instructions, a memory for storing the instructions, and a display device for presenting images or videos. The instructions, when executed by the processor, cause the system to apply a numerical mask to adjust contrast, reduce reflections, and enhance colors in specific areas of the display. The system then renders a processed image or video with these polarization-mimicking or privacy-enhancing effects on the digital display.

In an alternate embodiment of the present invention, there is a system where the numerical mask is dynamically adjustable based on the content of the digital image or video. This allows for real-time optimization of contrast adjustments, reflection reduction, and color enhancement to adapt to changes in the content being displayed.

In an alternate embodiment of the present invention, there is a system where an input device allows a user to manually adjust the intensity of the polarization-mimicking or privacy effects applied by the numerical mask. This gives the user control over how the visual effects are applied based on their personal preferences or situational needs.

In an alternate embodiment of the present invention, there is a system where the numerical mask is dynamically adjusted based on real-time feedback from ambient light sensors and orientation sensors in the display device. This ensures that the polarization and privacy effects are optimized for varying environmental conditions, such as changing light levels or the angle at which the user is viewing the screen.

In an alternate embodiment of the present invention, there is a system where the user interface allows the viewer to manually adjust the levels of contrast reduction, reflection suppression, and color enhancement. This customizable interface enables the user to fine-tune the privacy effects to match their specific needs.

In an alternate embodiment of the present invention, there is a system where the numerical mask is combined with a physical polarizing filter to further enhance the polarization-mimicking effects on the digital image or video. This hybrid approach maximizes the privacy and visual quality for the user.

In an alternate embodiment of the present invention, there is a method where the numerical mask is applied in combination with a physical privacy screen. This further narrows the effective viewing angle, enhancing privacy protection while maintaining a high level of visual clarity for the user directly in front of the screen.

In an alternate embodiment of the present invention, there is a method where the numerical mask is applied selectively to certain regions of the screen, such as areas displaying sensitive information. This allows for privacy effects to be focused on sensitive areas while leaving other regions unaffected, balancing privacy and usability.

In an alternate embodiment of the present invention, there is a system where the numerical mask is applied selectively to different regions of the display based on real-time content analysis. This enhances privacy or visual effects in certain areas while maintaining normal viewing in others, further optimizing the user's experience.

The claims define a method and system for using a numerical mask to mimic the visual effects of polarization in digital images and videos. The primary functions include adjusting contrast, reducing reflections, and enhancing colors in specific areas. The claims cover various aspects of this process, including gradient application, dynamic adjustment, and user control, providing a comprehensive framework for implementing this technology in digital imaging devices and software.

The claims focus on using a digital mask to mimic polarization effects for the specific purpose of enhancing privacy on smartphones, tablets, and computer screens. The key aspects include adjusting contrast, reducing reflections, and enhancing colors to limit visibility from side angles, making it difficult for unauthorized viewers to see the content unless they are directly in front of the screen. The claims also cover dynamic adjustments based on environmental conditions and user customization, offering a comprehensive approach to private viewing.

The invention presents several advantages over existing privacy technologies and effectively addresses problems that have been persistent in prior art.

Dynamic and Context-Aware Privacy Protection: Advantage: The digital mask offers dynamic adjustments in real-time based on environmental factors such as ambient light and the viewer's angle. This ensures that the privacy protection adapts to different conditions, maintaining effectiveness where traditional solutions might fail. Problem Solved: Existing privacy solutions like physical filters are static and do not adjust to changing environments, leading to inconsistent privacy protection, especially in bright or low-light conditions.

Selective Privacy Application: Advantage: The invention allows for selective application of privacy effects, targeting specific areas of the screen, such as sections displaying sensitive information. This prevents unnecessary obscuration of non-sensitive content, preserving usability. Problem Solved: Traditional privacy filters and most software solutions apply a uniform effect across the entire screen, which can reduce usability by obscuring content that does not require privacy protection. The ability to selectively target screen areas offers a more refined and user-friendly experience.

User Customization: Advantage: The invention provides users with the ability to customize the level of privacy protection, such as adjusting the intensity of contrast reduction, reflection suppression, and color enhancement according to their preferences. Problem Solved: Prior art typically lacks customization, offering only a one-size-fits-all approach. This can lead to either insufficient or excessive privacy effects, depending on the user's needs and the specific situation. Customization allows users to tailor the privacy settings to their specific requirements, improving overall satisfaction.

Device-Independent and Cost-Effective: Advantage: The digital mask is software-based and can be implemented on a wide range of devices without the need for specialized hardware, making it more accessible and cost-effective compared to hardware-dependent solutions like integrated privacy screens. Problem Solved: Hardware-dependent privacy technologies, such as those requiring built-in privacy filters, are limited to specific devices and models. This restricts their availability and increases costs. The software-based approach can be deployed broadly across different platforms, providing a more versatile solution.

Enhanced Privacy in High Ambient Light Conditions: Advantage: The invention is optimized for environments with high ambient light, where traditional privacy filters often struggle. By dynamically adjusting the screen's contrast and reducing reflections, it ensures effective privacy protection even in bright conditions. Problem Solved: Physical privacy filters and static software solutions often lose effectiveness in bright environments, where reflections and glare can reduce the clarity of the protected content. The invention's ability to adapt to these conditions maintains the integrity of privacy protection.

The invention provides a sophisticated and flexible solution to screen privacy that addresses several limitations found in existing technologies. By offering dynamic adjustments, selective application, user customization, and broad device compatibility, it not only improves privacy protection but also enhances the overall user experience. This innovation represents a significant advancement over the static, less adaptable solutions currently available in the market.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A method for enhancing visual effects or privacy on a digital display, comprising:
(A) Receiving a digital image or a video data intended for display on a screen;
(B) Applying a numerical mask to said digital image or said video data, wherein said numerical mask is configured to:
(i) Adjust a contrast in specific regions to mimic an enhanced contrast of polarized light or reduce visibility from side viewing angles;
(ii) Reduce an intensity of reflections in identified reflective areas to minimize glare or enhance private viewing;
(iii) Enhance a color saturation in predetermined areas to simulate polarized light effects or improve private viewing by enhancing colors for a viewer positioned directly in front of said screen; and
(C) Outputting a processed image or video on said digital display with an enhanced visual effect or a privacy adjustment applied.

2. A system for providing enhanced visual effects or privacy on a digital display, comprising:
(A) A processor configured to execute instructions;
(B) A memory for storing said instructions;
(C) A display device for presenting an image or a video;
(D) Said instructions, when executed by said processor, cause said system to:
(i) Apply a numerical mask to adjust contrast, reduce reflections, and enhance colors in specific areas to mimic a polarization or limit a visibility to viewers directly in front of a screen; and
(ii) Render a processed image or a processed video on said digital display with polarization-mimicking effects or privacy-enhancing effects;
(E) An input device that allows a viewer to manually adjust an intensity of said polarization or a privacy effect.

3. A non-transitory computer-readable storage medium storing instructions that, when executed by a processor, cause a device to perform the method of claim 1.

4. The method of claim 1, wherein said numerical mask applies a gradient of contrast adjustments across said digital image or said video data to simulate a natural polarization gradient seen in outdoor scenes.

5. The method of claim 1, wherein a reduction of said intensity of reflections is achieved by identifying areas in said digital image or said video data that exhibit reflective properties based on pixel brightness and uniformity, and applying a blur reduction filter or an intensity reduction filter to an identified area.

6. The method of claim 1, wherein a color enhancement is selectively applied to areas containing a plurality of colors, including a blue of a sky or a green of a foliage, to replicate an effect of polarized light on said colors.

7. The method of claim 1, wherein said numerical mask is applied selectively to different frames of said video data based on motion detection, ensuring that a polarization-mimicking effect is consistent and visually coherent throughout a video playback.

8. The method of claim 1, wherein said numerical mask applies a gradient that progressively reduces said contrast and a brightness toward any edge of said screen, making content difficult to discern from wider viewing angles.

9. The method of claim 1, wherein a reduction of said intensity of reflections is optimized for environments with high ambient light to further enhance private viewing.

10. The method of claim 1, wherein a color enhancement is selectively applied based on a viewing angle such that displayed colors are enhanced only in areas directly aligned with a line of sight of said viewer, while displayed colors are subdued at wider angles to obscure content from side viewers.

11. The system of claim 2, wherein said numerical mask is dynamically adjustable based on a content of said image or said video such that a contrast adjustment, a reflection reduction, and a color enhancement are optimized in real time.

12. The system of claim 2, further comprising said input device that allows a user to manually adjust said intensity of said polarization or said privacy effect applied by said numerical mask.

13. The system of claim 2, wherein said numerical mask is dynamically adjusted based on real-time feedback from ambient light sensors and orientation sensors of said display device to optimize said polarization or said privacy effect under varying environmental conditions.

14. The system of claim 2, further comprising a user interface that allows said viewer to manually adjust a level of contrast reduction, reflection suppression, and color enhancement to tailor said privacy effect to specific needs of said viewer.

15. The system of claim 2, wherein said numerical mask is combined with a physical polarizing filter to further enhance said polarization-mimicking effects on said image or said video.

16. The method of claim 1, wherein said numerical mask is applied in combination with a physical privacy screen to further narrow an effective viewing angle, enhancing a privacy effect.

17. The method of claim 1, wherein said numerical mask is applied selectively to certain regions of said screen while leaving other regions unaffected to balance privacy with usability.

18. The system of claim 2, wherein said numerical mask is applied selectively to different regions of said display device based on real-time content analysis to enhance privacy or visual effects in certain areas.
